(19) United States
(12) Patent Application Publication
(10) Pub. No.: US 2014/0247431 A1
(43) Pub. Date: Sep. 4, 2014

(54) PROJECTOR WITH LIGHT EMITTING DIODES

(71) Applicant: TERRY JAMES BOSS, St. Louis Park, MN (US)

(72) Inventor: TERRY JAMES BOSS, St. Louis Park, MN (US)

(21) Appl. No.: 14/273,568

(22) Filed: May 9, 2014

(51) Int. Cl. G03B 21/20; G03B 21/16; G03B 21/28

(52) U.S. Cl. CPC G03B 21/2033; G03B 21/28; G03B 21/16
USPC 353/52; 353/98; 353/121

(57) ABSTRACT

A projector with light emitting diodes for projecting images with less heat being generated. The projector with light emitting diodes includes a housing having side walls and front and back end walls and a first opening extending transversely through the front end wall and an image projecting assembly including a mirror disposed in the housing, a light source spatially arranged relative to the mirror and adapted to reflect an image off the mirror, and a lens assembly aligned with the first opening in the housing to project the reflected image outside the housing.

### BACKGROUND OF THE INVENTION

1. Field of the Invention

The present invention relates to projectors and more particularly pertains to a new projector with light emitting diodes for projecting images with less heat being generated.

2. Description of the Prior Art

The use of projectors is known in the prior art. More specifically, projectors heretofore devised and utilized are known to consist basically of familiar, expected and obvious structural, configurations, notwithstanding the myriad of designs encompassed by the crowded prior art which have been developed for the fulfillment of countless objectives and requirements.

The prior art includes a light emitting diode (LED) light source comprising an LED die, or a closely packed die array or matrix of die arrays, substantially and efficiently coupled to non-imaging collection optics. The non-imaging collection optics operate to provide a homogenized LED output having a near field whose intensity is highly uniform and a reduced far field extent substantially preserving the etendue (area, solid angle, index squared product) of the LED output. The near field, in turn, is imaged by a downstream relay lens to an illumination plane a specific distance away. Another prior art includes a multi colour LED, in which layers for generating light of different colors are arranged one above the other, is used as the light source in a projector. While these devices fulfill their respective, particular objectives and requirements, the aforementioned patents do not disclose a new projector with light emitting diodes.

### SUMMARY OF THE INVENTION

The general purpose of the present invention which will be described subsequently in greater detail, is to provide a new projector with light emitting diodes which has many of the advantages of the projectors mentioned heretofore and many novel features that result in a new projector with light emitting diodes which is not anticipated, rendered obvious, suggested, or even implied by any of the prior art projectors either alone or in any combination thereof. The present invention includes a housing having side walls and front and back end walls and a first opening extending transversely through the front end wall and an image projecting assembly including a mirror disposed in the housing, a light source spatially arranged relative to the mirror and adapted to reflect an image off the mirror, and a lens assembly aligned with the first opening in the housing to project the reflected image outside the housing. None of the prior art includes the combination of the elements of the present invention.

There has thus been outlined, rather broadly, the more important features of the projector with light emitting diodes in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new projector with light emitting diodes which has many of the advantages of the projectors mentioned heretofore and many novel features that result in a new projector with light emitting diodes which is not anticipated, rendered obvious, suggested, or even implied by any of the prior art projectors, either alone or in any combination thereof.

Still another object of the present invention is to provide a new projector with light emitting diodes for projecting images while less energy and generating less heat.

Still yet another object of the present invention is to provide a new projector with light emitting diodes that provides more linear and even lighting rather than scattered lighting from incandescent bulbs to effectively project the image.

Even still another object of the present invention is to provide a new projector with light emitting diodes positioned at a particular angle relative to a mirror to effectively and efficiently project the image.

These together with other objects of the invention, along with the various features of novelty which characterize the invention, are pointed out with particularity in the claims annexed to and forming a part of this disclosure. For a better understanding of the invention, its operating advantages and the specific objects attained by its uses. reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new projector with tight emitting diodes according to the present invention.

FIG. 2 is an exploded perspective view of the present invention.

FIG. 3 is a block diagram of the method of using the present invention to project an image.

### DETAILED DESCRIPTION OF THE INVENTION

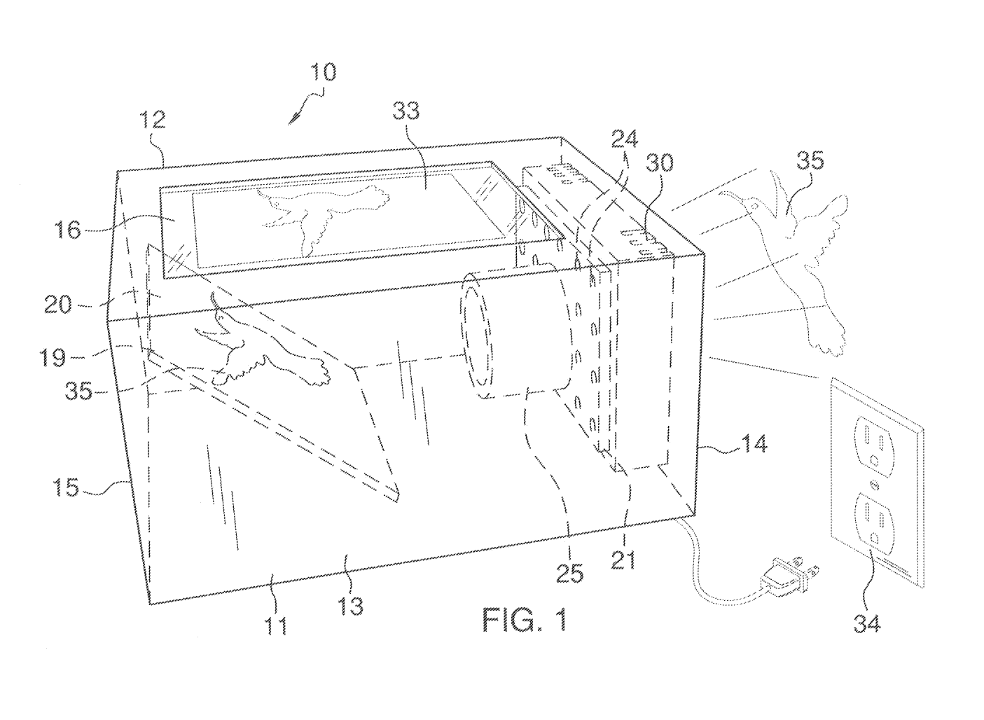

With reference now to the drawings, and in particular to FIGS. 1 through 3 thereof, a new projector with light emitting diodes embodying the principles and concepts of the present invention and generally designated by the reference numeral 10 will be described.

As best illustrated in FIGS. 1 through 3, the projector with light emitting diodes 10 may generally comprise a housing 11 having side walls 12, 13 and front and back end walls 14, 15 and an first opening 17 extending transversely through the front end wall 14, and may also comprise an image projecting assembly 18 including a mirror 19 conventionally set up and disposed in the housing 11 and also including a light source 42 spatially arranged relative to the mirror 19 and adapted to be energized by a power source 34 and to transmit light to the mirror 19, and further including a leas assembly 25 conventionally disposed in the housing 11 and aligned with the first opening 17 in the housing 11 to project the reflected image 35 of the object 33 outside the housing 11. The housing 11 also may have a second opening 36 through one of the side walls 12 and adapted to view the object 33 therethrough.

As shown in FIG. 1 the light source 32 may include a rigid planar support member 21 having a planar surface 22 which is arranged parallel to planar sides of the front end wall 14 and faces the mirror 19 and also may include light emitting diodes 24 conventionally concentrated upon the planar surface 22 of the support member 21 and energizable by a power source to concentrate linear beams of light to the minor 19. The support member 21 may be conventionally disposed proximate to the front end wall 14. The planar support member 21 may have a central opening 23 extending transversely therethrough with the light emitting diodes 24 conventionally concentrated on and attached to the planar surface 22 20 about the central opening 23. The opening 23 of the planar support member 21 and first opening 17 may be axially aligned.

As also shown in, FIG. 1, the mirror 19 may have a planar reflective surface 20 which is angled approximately 45 degrees to the planar surface 22 of the support member 21 with the light emitting diodes 24 positioned to emit linear beams of light to the reflective surface 20 of the mirror 19. The light emitting diodes 24 may be spaced from the mirror 19. The housing 11 also may further have a window 16 conventionally disposed in the second opening 36 and 30 adapted to view an object 33 therethrough. The window 16 may have a planar surface which is angled approximately 45 degrees to the reflective surface of the mirror 19.

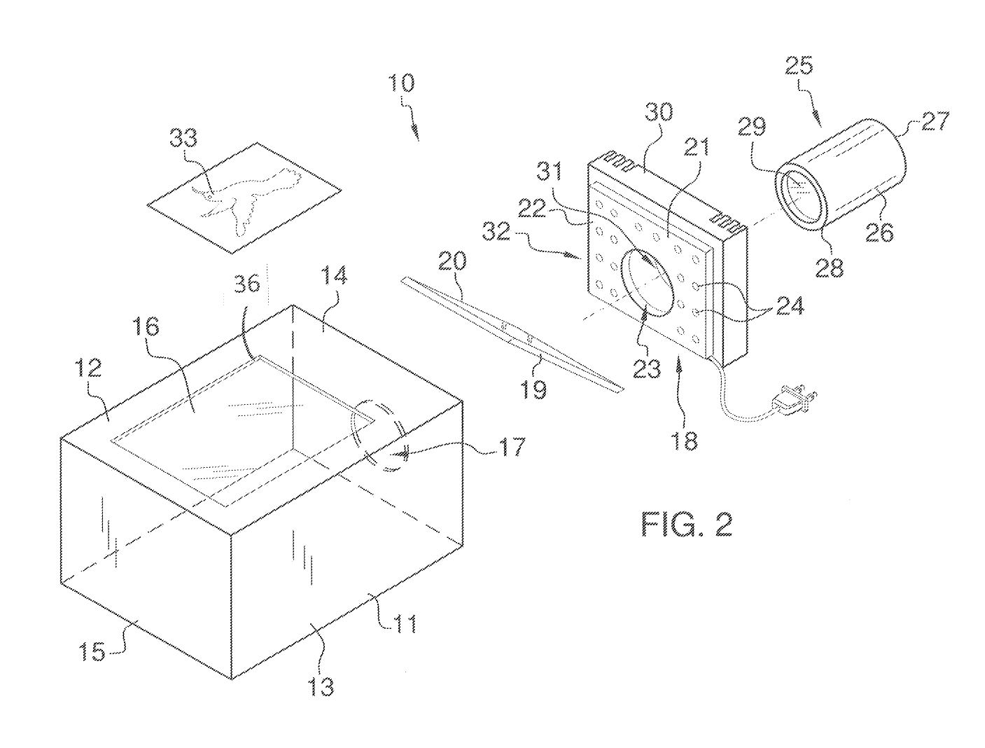

As illustrated in FIGS. 1 and 2, the lens assembly 25 may include a hollow tubular member 26 having a distal end portion 27 conventionally disposed through and engaged with the central opening 23 of the support member 21 and being in axial alignment with the first opening 17 through the front end wall 14. The tubular member 26 may also have a proximate end portion 28 which extends between the light emitting diodes 24 and the mirror 19 in the housing 11. The lens assembly 25 may further include at least one lens 29 conventionally disposed in the tubular member 26 to project the image 35 of the object 33 reflected from the mirror 19 to outside the housing 11. The tubular member 26 may have a longitudinal axis which is disposed approximately perpendicular to the planar surface 22 of the support member 21 and approximately 135 degrees to the reflective surface of the mirror 19. The image projecting assembly 18 may also include a heat sink 30 such as a heat exchanger conventionally coupled to the support member 21 with an opening 31 extending transversely therethrough and axially aligned with the opening 21 through the support member 21 and the first opening 17 to cool the support member 21 when the light emitting diodes 24 are energized to illuminate an object and project the image 35 of the object 33 outside the housing 11.

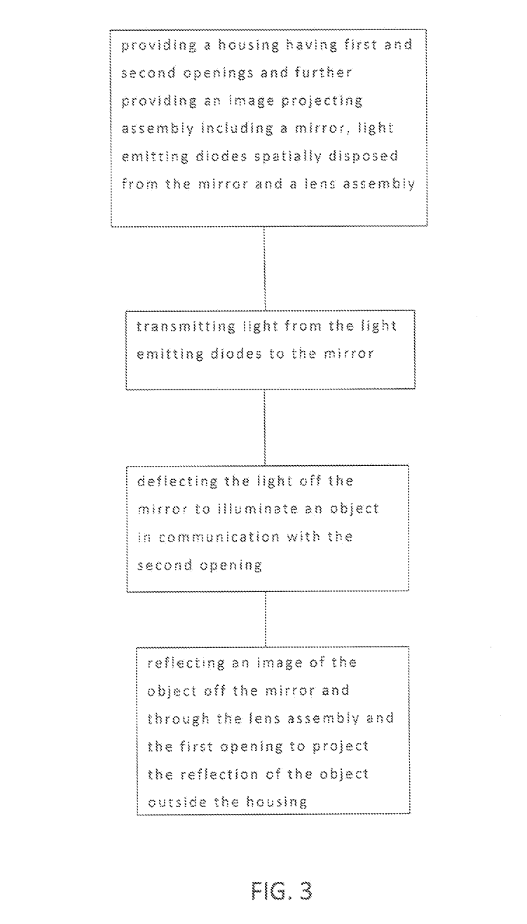

In use as illustrated in FIG. 3, the light emitting diodes 24 once energized by the conventional power source transmits beams of linear light to the mirror 19 and in particular to the reflective surface 20 of the mirror 19. The beams of light are deflected off the mirror 19 to illuminate an object 33 in communication with the second opening 36. The object 33 to be illuminated and projected is positioned in the second opening 36. The image 35 of the illuminated object 33 is projected upon the reflective surface 20 of the mirror 19 and the reflection of the object 33 is reflected off the mirror 19 and through the lens assembly 25 and the opening 17 of the rousing 11 to project the image reflection outside the housing 11. The lens assembly is positioned in the housing 11 to transmit the reflection of the object 33 from the mirror 19 through the lens assembly to outside the housing 11.

As to a further discussion of the manner of usage and operation of the present invention, the same should be apparent from the above description. Accordingly, no further discussion relating to the manner of usage and operation will be provided.

With respect to the shove description then, it is to be realized that the optimum dimensional relationships for the parts of the invention, to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the projector with light emitting diodes. Further, since numerous modifications and chances will readily occur to those skilled in the art, it is not desired to limit the invention to the exact construction and operation shown and described, and accordingly, all suitable modifications and equivalents may be resorted to, falling within the scope of the invention.

I claim:

1. A projector with light emitting diodes comprising:
a housing having side walls and front and back end walls and a first opening extending transversely through the front end wall; and
an image projecting assembly including a mirror disposed in the housing, a light source spatially arranged relative to the mirror and adapted to transmit and deflect light off the mirror and a lens assembly aligned with the first opening in the housing to project a reflected image outside the housing.

2. The projector with light emitting diodes as described in claim 1, wherein the housing also has a second opening in one of the side walls and adapted to view an object therethrough.

3. The projector with tight emitting diodes as described in claim 2, wherein the light source includes a planar support member having a planar surface which is arranged parallel to planar sides of the front end wall and faces the mirror and also includes tight emitting diodes concentrated upon the planar surface of the support member and energizable by a power source to concentrate linear beams of light to the mirror, wherein the support member is disposed proximate to the front end wall.

4. The projector with light emitting diodes as described in claim 3, wherein the planar support member has a central opening extending transversely therethrough with the light emitting diodes concentrated on the planar surface about the central opening, wherein the opening of the planar support member and the first opening through the front end wall are axially aligned.

5. The projector with light emitting as described in claim 2, wherein the mirror has a planar reflective surface which is angled approximately 45 degrees to the planar surface of the support member with the light emitting diodes positioned to emit linear beams of light to the reflective surface of the mirror whereto the light emitting diodes are spaced from the mirror.

6. The projector with light emitting diodes as described in claim 5, wherein the housing further has a window disposed in the second opening and adapted to view the object therethrough.

7. The projector with light emitting diodes as described in claim 6, wherein the window has a planar surface which is angled approximately 45 degrees to the reflective surface of the mirror.

8. The projector with light emitting diodes as described in claim 4, wherein the lens assembly includes a hollow tubular member having a distal end portion disposed through the central opening of the support member and being in axial alignment with the first opening through the front end wall.

9. The projector with light emitting diodes as described in claim 8, wherein the tubular member also has a proximate end portion which extends between the light-emitting diodes and the mirror, wherein the lens assembly also includes at least one lens disposed in the tubular member to project the image of the object reflected from the mirror to outside the housing.

10. The projector with light emitting diodes as described in claim 9, wherein the tabular member has a longitudinal axis which is disposed approximately perpendicular to the planar surface of the support member and approximately 135 degrees to the reflective surface of the mirror.

11. The projector with light emitting diodes as described in claim 4, wherein the image projecting assembly further includes a heat sink member coupled to the support member with an opening extending transversely therethrough and axially aligned with the opening through the support member and first opening through the front end wall to cool the support member when the projector is in use.

12. A method of projecting an image using light emitting diodes comprising the steps of:
providing a housing haying a first opening and also having a second opening through a side wall of the housing and further providing an image projecting assembly including a mirror having a planar reflective surface, light emitting diodes spatially disposed from the mirror and a lens assembly;
transmitting, light from the light emitting diodes to the mirror;
deflecting the light of the mirror to illuminate an object in communication with the second opening; and
reflecting an image of the object off the mirror and through the lens assembly and the first opening to project the reflection of the object outside the housing.

13. The method of projecting an image from a projector with light omitting diodes as described in claim 12, wherein the providing an image projecting assembly includes providing a support member having a planar surface with light emitting diodes concentrated upon the planar surface.

14. The method of projecting an image from a projector with light emitting diodes as described in claim 13, wherein the providing an image projecting assembly includes arranging the planar reflective surface of the mirror approximately 45 degrees to the planar surface of the support member.

15. The method of projecting an image from a projector with light emitting diodes as described in claim 12, wherein the providing an image projecting assembly further includes providing a window disposed in the second opening and having a planar surface.

16. The method of projecting an image from a projector with light emitting diodes as described in claim 15, wherein the providing an image projecting assembly includes arranging the reflective surface of the mirror approximately 45 degrees to the planar surface of the window.

17. The method of projecting an image from a protector with light emitting diodes as described in claim 12, wherein the transmitting light includes energizing the light emitting diodes from a power source whereupon linear beams of light from the light omitting diodes are transmitted to the reflective surface of the mirror.

18. The method of projecting an image from a projector with light emitting diodes as described in claim 12, wherein the deflecting the light includes positioning the object to be projected in the second opening in the side wall.

19. The method of projecting an image from a projector with light emitting diodes as described in claim 12, wherein the reflecting an image includes positioning, the lens assembly to transmit the reflection of the object from the mirror through the lens assembly to outside the housing.
